(19) United States
(12) Patent Application Publication
(10) Pub. No.: US 2026/0254342 A1
(43) Pub. Date: Aug. 27, 2026

(54) MULTI-LEVEL PROCESSING SYSTEM

(71) Applicant: LITE-ON TECHNOLOGY CORPORATION, Taipei (TW)

(72) Inventors: Yong-Long SYU, Taipei (TW); Kai-De CHEN, Taipei (TW); Yu-Hsin WU, Taipei (TW); Chen CHEN, Taipei (TW)

(21) Appl. No.: 19/382,322

(22) Filed: Nov. 7, 2025

Related U.S. Application Data
(60) Provisional application No. 63/763,325, filed on Feb. 26, 2025.

(30) Foreign Application Priority Data
Sep. 11, 2025 (CN) 202511297186.6

(51) Int. Cl. H02M 1/00; H02M 1/42; H02M 7/25

(52) U.S. Cl. CPC H02M 1/0095; H02M 1/0025; H02M 1/4216; H02M 7/25

(57) ABSTRACT

A multi-level processing system, includes a multi-level converter, a voltage detection circuit and a control circuit. The multi-level converter includes a key element, several control switch elements and several target switch elements. The key element is electrically coupled to at least one of the control switch elements, and the key element has a voltage parameter set. The voltage detection circuit is electrically coupled to the key element of the multi-level converter to detect the voltage parameter set, and generate a detection voltage set according to the voltage parameter set. The control circuit is electrically coupled to the voltage detection circuit to receive the detection voltage set, and takes the detection voltage set as a control voltage set of the control circuit.

This application claims the benefit of U.S. provisional application Ser. No. 63/763,325, filed Feb. 26, 2025, and CN application Serial No. 202511297186.6, filed Sep. 11, 2025, the disclosures of which are incorporated by reference herein in its entirety.

### TECHNICAL FIELD

The present disclosure relates to a multi-level circuit architecture, and more particularly relates to a multi-level processing system with a voltage detection function.

### BACKGROUND

With the evolution of artificial intelligence technology, high power density applications are increasingly utilized, which generally employ a multi-level circuit architecture to meet the demand for high power density. The multi-level circuit architecture is applicable to power products such as car chargers, laptop chargers, artificial intelligence server power supplies and brick power supplies, etc.

In the multi-level circuit architecture, capacitors, inductors and target switch elements are stacked or connected in series, so as to reduce the withstand voltage of the target switch element, and reduce the volume of the magnetic element. The capacitor element within the multi-level circuit architecture is positively correlated with the withstand voltage of the target switch element; therefore, the voltage across the capacitor element must be monitored to maintain it within a predetermined range, so as to ensure that the voltage across the target switch element does not exceed a rated value of the element.

In view of the above issues, a voltage detection circuit and a downstream control circuit must be provided for the capacitor element in the multi-level circuit architecture, so as to effectively monitor the voltage across the capacitor element. In addition, the voltage detection circuit for the capacitor element must be adapted for a difference between the voltage reference level of a control chip and the voltage reference level of the capacitor element.

### SUMMARY

According to one embodiment of the present disclosure, a multi-level processing system is provided. The multi-level processing system includes a multi-level converter, a voltage detection circuit and a control circuit. The multi-level converter includes a key element, several control switch elements and several target switch elements. The key element is electrically coupled to at least one of the control switch elements, and the key element has a voltage parameter set. The voltage detection circuit is electrically coupled to the key element of the multi-level converter to detect the voltage parameter set, and generate a detection voltage set according to the voltage parameter set. The control circuit is electrically coupled to the voltage detection circuit to receive the detection voltage set, and takes the detection voltage set as a control voltage set of the control circuit.

### BRIEF DESCRIPTION OF THE DRAWINGS

FIG. 1 is a block diagram of a multi-level processing system 2000 according to an embodiment of the present disclosure.

FIG. 2A is a circuit diagram of the multi-level converter 1000 and the voltage detection circuit 100 according to an embodiment of the present disclosure.

FIG. 2B is a detailed circuit diagram of one embodiment of the voltage detection circuit 100 of FIG. 2A.

FIG. 2C is a detailed circuit diagram of another embodiment of the voltage detection circuit 100 of FIG. 2A.

FIG. 3A is a circuit diagram of the multi-level converter 1000 of the present disclosure and a voltage detection circuit 100b in another embodiment.

FIG. 3B is a detailed circuit diagram of the voltage detection circuit 100b in FIG. 3A.

FIG. 4 is a circuit diagram of a multi-level converter 1000 and an isolated voltage sensor 150 of a comparative example.

FIG. 5A is a circuit diagram of a multi-level converter 1010 and voltage detection circuits 100-1 and 100-2 according to another embodiment of the present disclosure.

FIG. 5B is a circuit diagram of a multi-level converter 1010 and voltage detection circuits 100b-1 and 100b-2 according to another embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

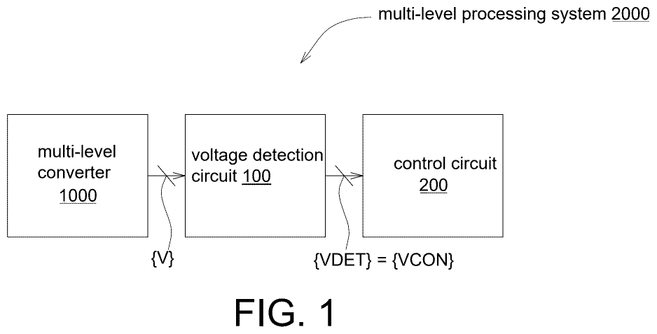

FIG. 1 is a block diagram of a multi-level processing system 2000 according to an embodiment of the present disclosure. As shown in FIG. 1, the multi-level processing system 2000 includes a multi-level converter 1000, a voltage detection circuit 100 and a control circuit 200. The multi-level converter 1000 includes a key element, several control switch elements and several target switch elements (the key element, control switch elements and target switch elements are not shown in FIG. 1). The multi-level converter 1000 may include the following types, for example, a series capacitor buck, a symmetric series capacitor buck, a flying capacitor totem-pole boost PFC, a Vienna PFC, a multi-level LLC resonant converter, etc. In addition, the control circuit 200 includes a controller, such as a micro control unit (MCU), a digital signal processor (DSP), etc., and is not limited thereto.

The voltage detection circuit 100 is electrically coupled to the multi-level converter 1000 to detect a voltage parameter set {V} of the key element of the multi-level converter 1000. Furthermore, the voltage detection circuit 100 generates a detection voltage set {VDET} based on the voltage parameter set {V} of the key element.

The control circuit 200 is electrically coupled to the voltage detection circuit 100 to receive the detection voltage set {VDET} generated by the voltage detection circuit 100. Furthermore, the control circuit 200 employs the detection voltage set {VDET} as the control voltage set {VCON} of the control circuit 200. Furthermore, the control circuit 200 performs a control operation based on the control voltage set {VCON}.

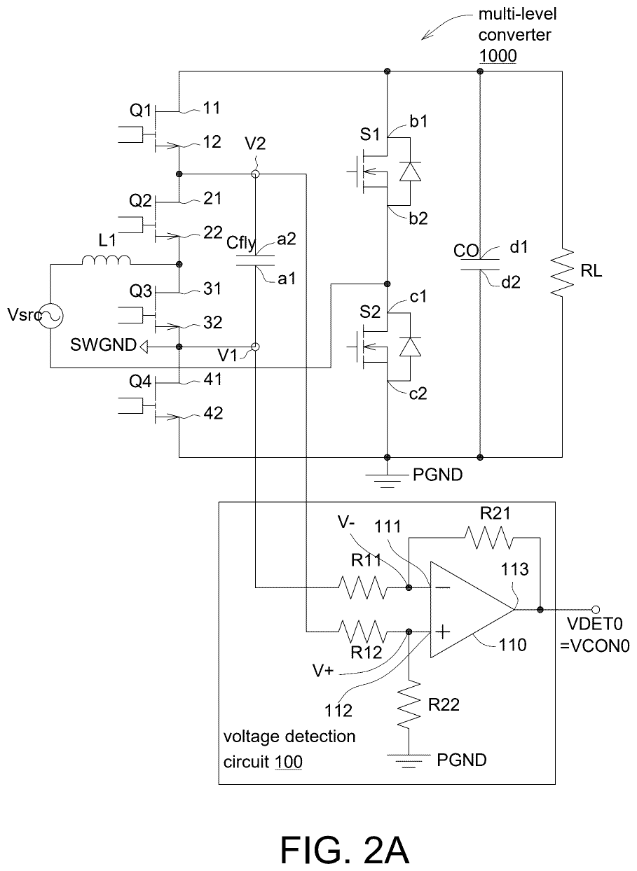

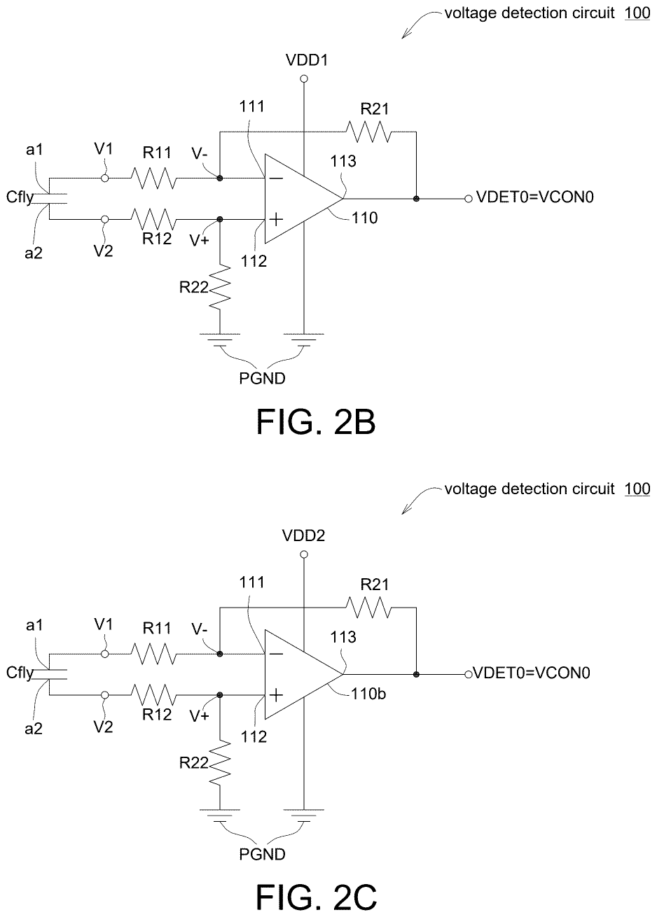

FIG. 2A is a circuit diagram of the multi-level converter 1000 and the voltage detection circuit 100 according to an embodiment of the present disclosure. The multi-level converter 1000 of the embodiment of FIG. 2A is, for example, a three-level flying capacitor totem-pole PFC. As shown in FIG. 2A, the multi-level converter 1000 includes a control switch element Q₁, a control switch element Q₂, a control switch element Q₃, a control switch element Q₄, a flying capacitor C_{fly}, a target switch element S₁, a target switch element S₂, and an output capacitor C_{O}. The flying capacitor C_{fly} is a key element of the multi-level converter 1000 and is electrically coupled to at least one of the control switch elements Q₁-Q₄. The multi-level converter 1000 is coupled to an input voltage source V_{src} via an inductor L1, and the output capacitor C_{O} of the multi-level converter 1000 is connected with a load resistor R_{L} in parallel. More specifically, the control switch elements Q₁-Q₄ can be various types of elements with switching functions, including transistors of different materials (e.g., a metal oxide semiconductor field effect transistor (MOSFET), a gallium nitride field effect transistor (GaNFET), a silicon carbide (SiC) transistor, etc.). The control switch elements Q₁-Q₄ are connected in series. The second end 22 of the control switch element Q₂ and the first end 31 of the control switch element Q₃ are commonly coupled to the inductor L1. The flying capacitor C_{fly} is connected across at least two of the control switch elements Q₁-Q₄. For example, the flying capacitor C_{fly} is connected across the control switch element Q₂ and the control switch element Q₃. The first end 21 of the control switch element Q₂ is coupled to the second end a2 of the flying capacitor C_{fly}, and the second end 32 of the control switch element Q₃ is coupled to the first end a1 of the flying capacitor C_{fly}.

The flying capacitor C_{fly} and at least one of the control switch elements Q₁-Q₄ are electrically coupled to a first ground end SWGND (the first ground end SWGND is also referred to as a “switching end”). For example, the first end a1 of the flying capacitor C_{fly}, the second end 32 of the control switch element Q₃, and the first end 41 of the control switch element Q₄ are commonly coupled to the first ground end SWGND. Furthermore, the second end 42 of the control switch element Q₄ is coupled to a second ground end PGND (the voltage level of the second ground end PGND is the output voltage reference level). The potential (i.e., voltage level) of the first ground end SWGND is different from the potential (i.e., voltage level) of the second ground end PGND.

On the other hand, although the target switch elements S₁ and S₂ and the control switch elements Q₁-Q₄ are all switch elements, the roles and functions of the target switch elements S₁ and S₂ are different from those of the control switch elements Q₁-Q₄; the operations of the target switch elements S₁ and S₂ are controlled by the control switch elements Q₁-Q₄. Specifically, the target switch elements S₁ and S₂ are connected in series. The first end b1 of the target switch element S₁ is coupled to the first end 11 of the control switch element Q₁ and the first end d1 of the output capacitor C_{O}. The second end b2 of the target switch element S₁ and the first end c1 of the target switch element S₂ are commonly coupled to the input voltage source V_{src}. Furthermore, at least one of the target switch elements S₁ and S₂ is electrically coupled to the second ground end PGND. For example, the second end c2 of the target switch element S₂ is coupled to the second ground end PGND; and the second end 42 of the control switch element Q₄ and the second end d2 of the output capacitor C_{O} are also coupled to the second ground end PGND.

The flying capacitor C_{fly} is a key element of the multi-level converter 1000. The flying capacitor C_{fly} has a voltage parameter set {V}. The voltage parameter set {V} includes a first end voltage V1 of the first end a1 and a second end voltage V2 of the second end a2 of the flying capacitor C_{fly}. The voltage detection circuit 100 is coupled to the first end a1 and the second end a2 of the flying capacitor C_{fly} to detect the first end voltage V1 and the second end voltage V2 of the flying capacitor C_{fly}. Furthermore, the voltage detection circuit 100 generates a differential detection voltage VDET0 based on the first end voltage V1 and the second end voltage V2 of the flying capacitor C_{fly}. Furthermore, the differential detection voltage VDET0 is provided to the control circuit 200 of FIG. 1 to serve as the control voltage VCON0 of the control circuit 200. In other words, the detection voltage set {VDET} of FIG. 1 includes the differential detection voltage VDET0 of FIG. 2A, and the control voltage set {VCON} of FIG. 1 includes the control voltage VCON0 of FIG. 2A.

The voltage reference level of the flying capacitor C_{fly} is the voltage level of the first ground end SWGND, and the voltage reference level of the control circuit 200 is the voltage level of the second ground end PGND. The voltage reference level of the flying capacitor C_{fly} is different from the voltage reference level of the control circuit 200. The voltage detection circuit 100 directly detects the voltage between the second end a2 and the first end a1 of the flying capacitor C_{fly} (i.e., the difference (V2−V1) between the second end voltage V2 and the first end voltage V1 of the flying capacitor C_{fly}), thereby eliminating the difference in voltage between the first ground end SWGND and the second ground end PGND.

The voltage detection circuit 100 of the embodiment of FIG. 2A uses e.g., a differential amplifier 110 as a main element, and the differential amplifier 110 operates in conjunction with a first peripheral resistor R₁₁, a second peripheral resistor R₁₂, a third peripheral resistor R₂₁, and a fourth peripheral resistor R₂₂. More specifically, the differential amplifier 110 includes a first input end 111, a second input end 112 and an output end 113. The first input end 111 receives a first input voltage V−, and the second input end 112 receives a second input voltage V+. The first input voltage V− is substantially equal to the second input voltage V+. Furthermore, the output end 113 outputs a differential detection voltage VDET0.

The first input end 111 of the differential amplifier 110 is coupled to the first end a1 of the flying capacitor C_{fly} via the first peripheral resistor R₁₁; therefore, the first input voltage V− received by the first input end 111 is associated with the first end voltage V1 of the flying capacitor C_{fly}. Furthermore, the first input end 111 is coupled to the output end 113 via the third peripheral resistor R₂₁.

On the other hand, the second input end 112 of the differential amplifier 110 is coupled to the second end a2 of the flying capacitor C_{fly} via the second peripheral resistor R₁₂; therefore, the second input voltage V+ received by the second input end 112 is associated with the second end voltage V2 of the flying capacitor C_{fly}. Furthermore, the second input end 112 is coupled to the second ground end PGND via the fourth peripheral resistor R₂₂.

The differential amplifier 110 generates a differential detection voltage VDET0 in response to the first end voltage V1 and the second end voltage V2 of the flying capacitor C_{fly}, and outputs the differential detection voltage VDET0 via an output end 113.

FIG. 2B is a detailed circuit diagram of one embodiment of the voltage detection circuit 100 of FIG. 2A. In the design of the voltage detection circuit 100 of the embodiments of FIGS. 2A and 2B, the first peripheral resistor R₁₁ and the second peripheral resistor R₁₂ have the same first resistance value Ra, and the third peripheral resistor R₂₁ and the fourth peripheral resistor R₂₂ have the same second resistance value Rb.

The second end a2 of the flying capacitor C_{fly} is coupled to the second input end 112 of the differential amplifier 110 via the second peripheral resistor R₁₂, and further coupled to the second ground end PGND via the fourth peripheral resistor R₂₂. Furthermore, the input current of the second input end 112 of the differential amplifier 110 is approximately zero. Therefore, the second input voltage V+ of the differential amplifier 110 is equal to the product of the series voltage dividing ratio

$$( \frac{R b}{R a + R b} )$$

of the second peripheral resistor R₁₂ (having a first resistance value Ra) and the fourth peripheral resistor R₂₂ (having a second resistance value Rb) and the second end voltage V2 of the flying capacitor C_{fly}, as shown in formula (1-1) (wherein the second input voltage V+ of the differential amplifier 110 is also equal to the first input voltage V−):

$$V += V -= ( V 2 \times \frac{R b}{R a + R b} ) \qquad ( 1 - 1 )$$

In the operation of the multi-level converter 1000, the second end voltage V2 and the first end voltage V1 of the flying capacitor C_{fly} are both much greater than the withstand voltage of the control circuit 200 of FIG. 1, and the second end voltage V2 of the flying capacitor C_{fly} is, for example, n times the first end voltage V1 (i.e., the second end voltage V2 has a scaling factor “n” relative to the first end voltage V1). Furthermore, in the design of the voltage detection circuit 100, the first resistance value Ra of the first peripheral resistor R₁₁ and the second peripheral resistor R₁₂ is designed to be significantly greater than the second resistance value Rb of the third peripheral resistor R₂₁ and the fourth peripheral resistor R₂₂. Therefore, the sum of the resistance values (Ra+Rb) in equation (1-1) may approximate the first resistance value Ra, and hence equation (1-1) can be expressed as equation (1-2):

$$V + = V - ≅ ( n \times V 1 \times \frac{R b}{R a} ) \qquad ( 1 - 2 )$$

The differential amplifier 110 is coupled to a first voltage source VDD1. In operation, the first voltage source VDD1 serves as a reference voltage for the differential amplifier 110; the differential amplifier 110 operates based on the first voltage source VDD1. Therefore, the first input voltage V− and the second input voltage V+ of the differential amplifier 110 are less than or equal to the voltage value of the first voltage source VDD1, as shown in equation (1-3):

$$V + = V - ≅ ( n \times V 1 \times \frac{R b}{R a} ) \leq VDD 1 \qquad ( 1 - 3 )$$

According to the differential amplifying mechanism of the differential amplifier 110, the differential detection voltage VDET0 generated by differential amplifier 110 is equal to the product of the ratio (Rb/Ra) of the second resistance value Rb of the third peripheral resistor R₂₁ to the first resistance value Ra of the first peripheral resistor Ru and the difference (V2−V1) between the second end voltage V2 and the first end voltage V1 of the flying capacitor C_{fly}, as shown in equation (1-4) (wherein, the differential detection voltage VDET0 generated by the differential amplifier 110 is provided to the control circuit 200 to serve as the control voltage VCON0, and therefore the differential detection voltage VDET0 is also equal to the control voltage VCON0):

$$VDET 0 = VCON 0 = ( V 2 - V 1 ) \times \frac{R b}{R a} \qquad ( 1 - 4 )$$

As mentioned above, the second end voltage V2 of the flying capacitor C_{fly} is, for example, n times the first end voltage V1. Therefore, equation (1-4) can be expressed as equation (1-5):

$$VDET 0 = VCON 0 = ( n - 1 ) \times V 1 \times \frac{R b}{R a} \qquad ( 1 - 5 )$$

The differential amplifier 110 of the embodiment of FIG. 2B and the control circuit 200 of FIG. 1 share the same first voltage source VDD1; that is, the first voltage source VDD1 also serves as the reference voltage for the control circuit 200. The control circuit 200 operates based on the first voltage source VDD1, and hence the control voltage VCON0 of the control circuit 200 must be less than or equal to the voltage value of the first voltage source VDD1. Based on the relationship between the first input voltage V− (and the second input voltage V+) and the first voltage source VDD1 as expressed in equation (1-3), equation (1-5) can be further expressed as equation (1-6), where the differential detection voltage VDET0 generated by the differential amplifier 110 is less than or equal to

$$( \frac{n - 1}{n} \times VDD 1 ) .$$

$$VDET 0 = VCON 0 \leq ( \frac{n - 1}{n} \times VDD 1 ) \qquad ( 1 - 6 )$$

As shown in equation (1-6), the upper limit voltage value of the differential detection voltage VDET0 output by the differential amplifier 110 (also referred to as the “upper limit output voltage value” of the differential amplifier 110) is

$$( \frac{n - 1}{n} \times V D D 1 ) ;$$

that is, the upper limit voltage value of the differential detection voltage VDET0 is associated with the voltage value of the first voltage source VDD1 and the scaling factor “n”. The upper limit of the differential detection voltage VDET0 can only reach

$$( \frac{n - 1}{n} \times VDD 1 ) ,$$

thereby reducing the maximum dynamic range (also known as “signal resolution”) of the output signal of the voltage detection circuit 100.

FIG. 2C is a detailed circuit diagram of another embodiment of the voltage detection circuit 100 of FIG. 2A. In the embodiment of FIG. 2C, the differential amplifier 110b and the control circuit 200 of FIG. 1 do not share the same first voltage source VDD1. The control circuit 200 still uses the first voltage source VDD1 as a reference voltage (similar to the embodiment of FIG. 2B), but the differential amplifier 110b of FIG. 2C uses the second voltage source VDD2 as the reference voltage. The voltage value of the second voltage source VDD2 is different from the voltage value of the first voltage source VDD1. In operation, the second end voltage V2 of the flying capacitor C_{fly} is, for example, n times the first end voltage V1. Furthermore, the first input voltage V− and the second input voltage V+ of the differential amplifier 110b in FIG. 2C must be less than or equal to the voltage of the second voltage source VDD2, as shown in equation (2-1):

$$V + = V - ≅ ( n \times V 1 \times \frac{R b}{R a} ) \leq VDD 2 \qquad ( 2 - 1 )$$

The voltage value of the second voltage source VDD2 can be set to be greater than n/(n−1) times of the first voltage source VDD1, as shown in equation (2-2):

$$VDD 2 \geq ( \frac{n}{n - 1} ) \times VDD 1 \qquad ( 2 - 2 )$$

To meet the condition that the control voltage VCON0 of the control circuit 200 is less than the first voltage source VDD1 and further considering the condition of equation (2-2), the relationship of equation (2-3) can be obtained:

$$VDET {0}^{′} = VCON 0 = [ ( n - 1 ) \times V 1 \times \frac{R b}{R a} ] \leq VDD 1 \qquad ( 2 - 3 )$$

As can be seen from equation (2-3), the upper limit voltage value (i.e., the “upper limit output voltage value”) of the differential detection voltage VDET0′ generated by the differential amplifier 110b in FIG. 2C can reach the voltage of the first voltage source VDD1, which is superior to the “upper limit output voltage value” of the differential amplifier 110 in FIG. 2B reaching

$$\frac{n - 1}{n} \times VDD 1.$$

Therefore, the maximum dynamic range (i.e., “signal resolution”) of the output signal of the differential amplifier 110b in the embodiment of FIG. 2C is enhanced.

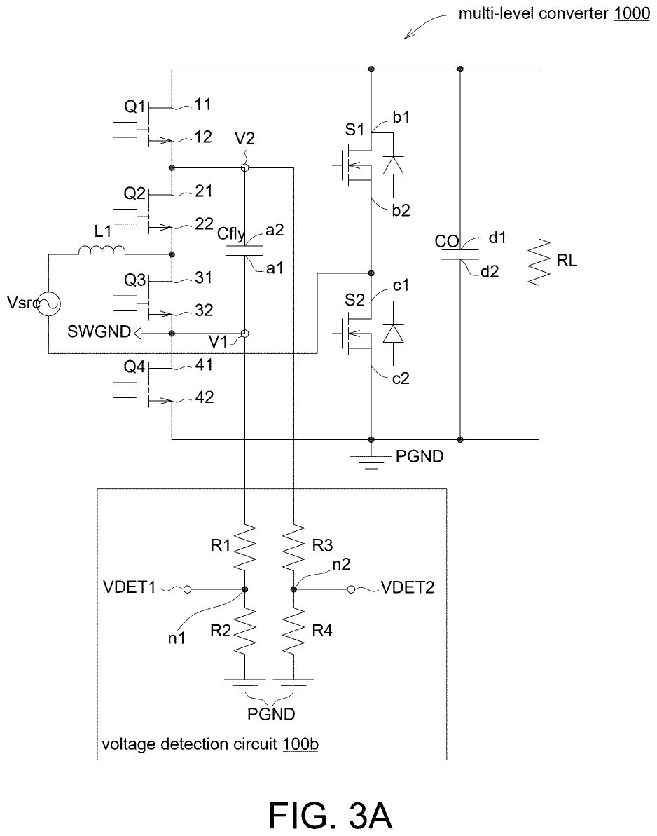

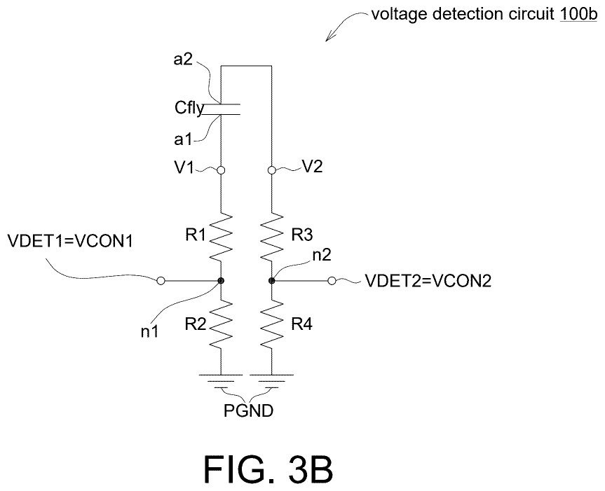

FIG. 3A is a circuit diagram of the multi-level converter 1000 of the present disclosure and a voltage detection circuit 100b in another embodiment; and FIG. 3B is a detailed circuit diagram of the voltage detection circuit 100b in FIG. 3A. Referring to FIGS. 3A and 3B, the multi-level converter 1000 of this embodiment is similar to the multi-level converter 1000 of FIG. 2A, however, the voltage detection circuit 100b of this embodiment operates based on a resistor dividing mechanism, which eliminates the need for a differential amplifier and hence needs not any voltage source.

More specifically, the voltage detection circuit 100b includes a first voltage dividing resistor R₁, a second voltage dividing resistor R₂, a third voltage dividing resistor R₃ and a fourth voltage dividing resistor R₄. The first voltage dividing resistor R₁ is coupled to the first end a1 of the flying capacitor C_{fly} to receive the first end voltage V1. The second voltage dividing resistor R₂ is coupled to the second ground PGND. The coupling point between the first and second voltage dividing resistors R₁ and R₂ is the node n1 which provides the first detection voltage VDET1.

Similarly, the third voltage dividing resistor R₃ is coupled to the second end a2 of the flying capacitor C_{fly} to receive the second end voltage V2. The fourth voltage dividing resistor R₄ is coupled to the second ground PGND. The coupling point between the third voltage dividing resistor R₃ and the fourth voltage dividing resistor R₄ is the node n2; and node n2 provides the second detection voltage VDET2. The first detection voltage VDET1 and the second detection voltage VDET2 are provided to the control circuit 200 in FIG. 1 as the control voltage VCON1 and the control voltage VCON2 of the control circuit 200 respectively. In other words, the detection voltage set {VDET} in FIG. 1 includes the first detection voltage VDET1 and the second detection voltage VDET2 in FIG. 3A, and the control voltage set {VCON} in FIG. 1 includes the control voltages VCON1 and VCON2 in FIG. 3A.

Unlike the differential amplifiers 110 and 110b of the embodiments of FIGS. 2B and 2C, which must rely on the first voltage source VDD1 and the second voltage source VDD2 for operation, the first voltage dividing resistor R₁, the second voltage dividing resistor R₂, the third voltage dividing resistor R₃ and the fourth voltage dividing resistor R₄ of this embodiment do not rely on any voltage source.

The first voltage dividing resistor R₁ of the voltage detection circuit 100b is disposed between the node n1 and the first end a1 of the flying capacitor C_{fly}, and the second voltage dividing resistor R₂ is disposed between the node n1 and the second ground end PGND. According to the resistor voltage dividing mechanism, the first detection voltage VDET1 provided by node n1 is equal to the product of the series voltage dividing ratio

$$( \frac{R b}{R a + R b} )$$

of the first voltage dividing resistor R1 (having a first resistance value Ra) and the second voltage dividing resistor R2 (having a second resistance value Rb) and the first end voltage V1 of the flying capacitor C_{fly}, as shown in equation (3-1) (wherein the first detection voltage VDET1 is also equal to the control voltage VCON1 of the control circuit 200):

$$VCON 1 = V = DET 1 = ( V 1 \times \frac{R b}{R a + R b} ) \qquad ( 3 - 1 )$$

Similar to the design of the voltage detection circuit 100 in the embodiments of FIGS. 2B and 2C, the first resistance value Ra of the first voltage dividing resistor R1 is designed to be much larger than the second resistance value Rb of the second voltage dividing resistor R2. In addition, the control voltage VCON1 of the control circuit 200 must be lower than the first voltage source VDD1. Based on the above conditions, equation (3-1) can be expressed as equation (3-2):

$$VDET 1 ≅ ( V 1 \times \frac{R b}{R a} ) \leq VDD 1 \qquad ( 3 - 2 )$$

On the other hand, similar to the resistor dividing mechanism for the first detection voltage VDET1 at node n1, the second detection voltage VDET2 provided by another node n2 of the voltage detection circuit 100b is equal to the product of the series voltage dividing ratio

$$( \frac{R d}{Rc + Rd} )$$

of the third voltage dividing resistor R3 (having a third resistance value Rc) and the fourth voltage dividing resistor R4 (having a fourth resistance value Rd) and the second end voltage V2 of the flying capacitor C_{fly}, as shown in equation (3-3) (wherein the second detection voltage VDET2 is also equal to the control voltage VCON2 of the control circuit 200):

$$VCON 2 = VDET 2 = ( V 2 \times \frac{R d}{R c + R d} ) \qquad ( 3 - 3 )$$

The second end voltage V2 of the flying capacitor C_{fly} is n times the first end voltage V1, and the third resistance value Rc of the third voltage dividing resistor R3 is much greater than the fourth resistance value Rd of the fourth voltage dividing resistor R4. Furthermore, the control voltage VCON2 of the control circuit 200 must be less than the first voltage source VDD1. Based on the above conditions, equation (3-3) can be expressed as equation (3-4):

$$VDET 2 ≅ ( V 2 \times \frac{R d}{R c} ) = ( n \times V 1 \times \frac{R d}{R c} ) \leq VDD 1 \qquad ( 3 - 4 )$$

According to equations (3-2) and (3-4), by appropriately adjusting the first resistance value Ra, the second resistance value Rb, the third resistance value Rc and the fourth resistance value Rd, the upper limit voltage value (also referred to as the “upper limit output voltage value” or “signal resolution”) of the first detection voltage VDET1 and the second detection voltage VDET2 generated by the voltage detection circuit 100b can reach the voltage value of the first voltage source VDD1. For example, the first resistance value Ra, the second resistance value Rb, the third resistance value Rc and the fourth resistance value Rd are adjusted to the relationship shown in equation (3-5):

$$\frac{R b}{R a} = ( n \times \frac{R d}{R c} ) \qquad ( 3 - 5 )$$

The first detection voltage VDET1 and the second detection voltage VDET2 generated by the voltage detection circuit 100b form a detection voltage set {VDET}. The control circuit 200 receives the detection voltage set {VDET} and uses the detection voltage set {VDET} as the control voltage set {VCON}; the control voltage set {VCON} includes a control voltage VCON1 (which is equal to the first detection voltage VDET1) and a control voltage VCON2 (which is equal to the second detection voltage VDET2). The control circuit 200 then performs a control operation based on the control voltages VCON1 and VCON2. In the embodiment of FIG. 3B, the control operation performed by the control circuit 200 is a subtraction operation, which is a subtraction operation between the control voltage VCON1 and the control voltage VCON2 (i.e., a subtraction operation between the first detection voltage VDET1 and the second detection voltage VDET2). As shown in equation (3-1), the first detection voltage VDET1 is equal to the product of the series voltage dividing ratio

$$( \frac{R b}{R a + R b} )$$

of the first resistor Ra and the second resistor Rb, and the first end voltage V1 of the flying capacitor C_{fly}. Furthermore, as shown in equation (3-2), the second detection voltage VDET2 is equal to the product of the series voltage dividing ratio

$$( \frac{R d}{Rc + Rd} )$$

of the third resistor value Rc and the fourth resistor value Rd and the second end voltage V2 of the flying capacitor C_{fly}. Therefore, the result of the subtraction operation performed by the control circuit 200 between the first detection voltage VDET1 and the second detection voltage VDET2 is associated with the difference (V2−V1) between the second end voltage V2 and the first end voltage V1 of the flying capacitor C_{fly}. In other words, the result of the subtraction operation performed by the control circuit 200 can be used to infer the voltage across the first end a1 and the second end a2 of the flying capacitor C_{fly}.

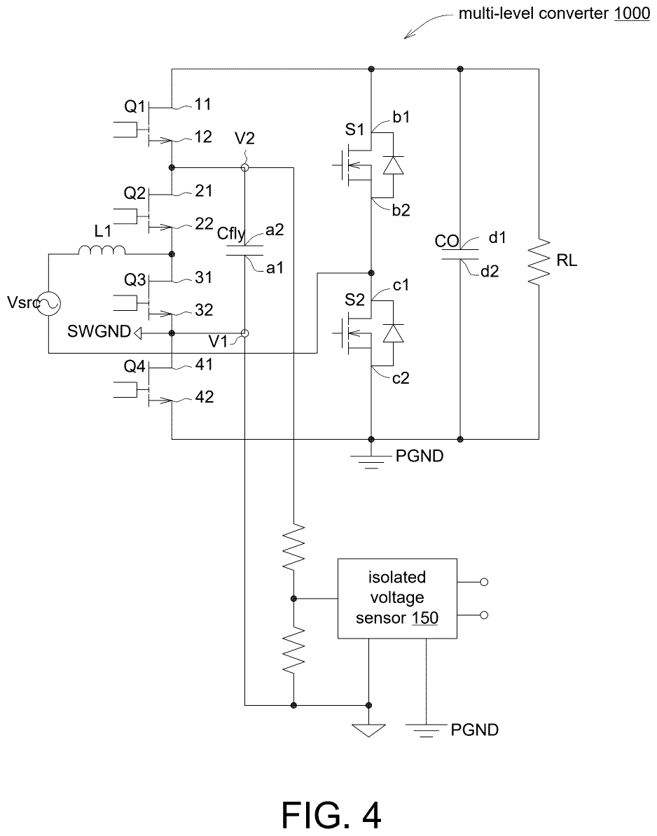

FIG. 4 is a circuit diagram of a multi-level converter 1000 and an isolated voltage sensor 150 of a comparative example. The comparative example in FIG. 4 represents a circuit architecture in prior arts. As shown in FIG. 4, the isolated voltage sensor 150 is used to sense the voltage across the first end a1 and the second end a2 of the flying capacitor C_{fly} of the multi-level converter 1000 (i.e., the difference (V2−V1) between the second end voltage V2 and the first end voltage V1). The isolated voltage sensor 150 provides potential isolation and serves as a voltage sampler for converting a voltage reference level, which may convert the voltage level of the first ground end SWGND to the voltage level of the second ground end PGND. The isolated voltage sensor 150 can be implemented using an isolated voltage detection circuit chip or an optical coupler, so as to convert the voltage reference level. However, the isolated voltage detection circuit chip or the optical coupler are relatively expensive in price and relatively large in size, increasing the overall size of the multi-level converter system. As the number of stages in the multi-level converter 1000 increases, the number of circuitry elements within the isolated voltage sensor 150 increases and further increases the overall size.

Compared to the isolated voltage sensor 150 of the comparative example in FIG. 4 which uses an expensive and large-area isolated voltage detection circuit chip or optical coupler, the voltage detection circuit 100 of the embodiment of FIGS. 2B and 2C of the present disclosure utilizes a differential amplifier 110, a first peripheral resistor R₁₁, a second peripheral resistor R₁₂, a third peripheral resistor R₂₁ and a fourth peripheral resistor R₂₂ with low-cost and small-area, thereby effectively reducing the overall size and cost of the multi-level conversion system.

On the other hand, the voltage detection circuit 100b of the embodiment of FIG. 3B of the present disclosure utilizes only a first voltage dividing resistor R₁, a second voltage dividing resistor R₂, a third voltage dividing resistor R₃ and a fourth voltage dividing resistor R₄, which eliminate the need for a differential amplifier and hence further reduce area and cost as compared to the embodiments of FIGS. 2B and 2C. Furthermore, a first voltage dividing resistor R₁, a second voltage dividing resistor R₂, a third voltage dividing resistor R₃ and a fourth voltage dividing resistor R₄ may operate without relying on a reference voltage source and hence further reduce the number of elements. Therefore, it may result in a smaller overall size for the multi-level conversion system.

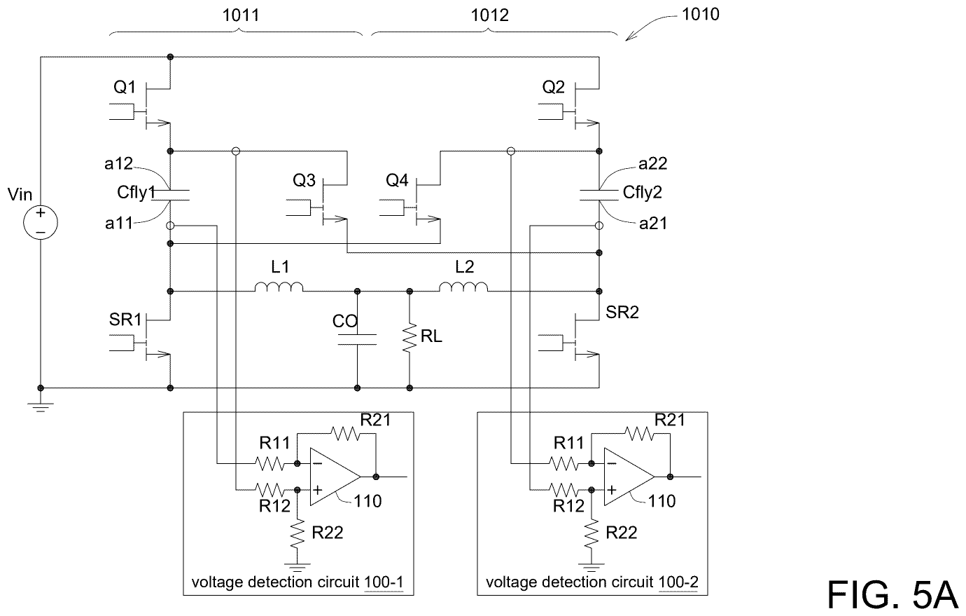

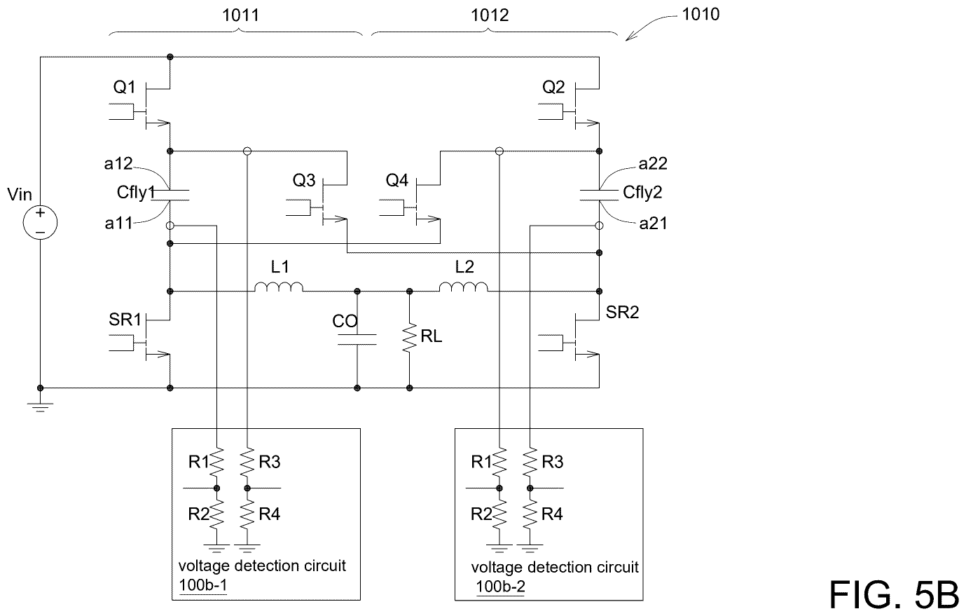

FIG. 5A is a circuit diagram of a multi-level converter 1010 and voltage detection circuits 100-1 and 100-2 according to another embodiment of the present disclosure. The multi-level converter 1010 of the embodiment of FIG. 5A is, for example, a symmetrical series capacitor buck converter. The multi-level converter 1010 includes a control switch element Q₁, control switch element Q₂, control switch element Q₃, control switch element Q₄, flying capacitor C_{fly1}, flying capacitor C_{fly2}, target switch element SR₁, target switch element SR₂, inductor L₁, inductor L₂, and output capacitor C_{O}.

More specifically, the multi-level converter 1010 includes a symmetrically arranged first circuit 1011 and a second circuit 1012. The first circuit 1011 includes the control switch element Q₁, control switch element Q₃, flying capacitor C_{fly1}, target switch element SR₁, and inductor L₁. On the other hand, the second circuit 1012 includes a control switch element Q₂, a control switch element Q₄, a flying capacitor C_{fly2}, a target switch element SR₂, and an inductor L₂. The flying capacitors C_{fly1} and C_{fly2} are key elements of the multi-level converter 1010.

The voltage detection circuit 100-1 is used to detect the voltage across the first end a11 and the second end a12 of the flying capacitor C_{fly1}. Similarly, the voltage detection circuit 100-2 is used to detect the voltage across the first end a21 and the second end a22 of the flying capacitor C_{fly2}. The voltage detection circuits 100-1 and 100-2 of this embodiment are similar to the voltage detection circuit 100 of the embodiment of FIG. 2B or FIG. 2C, which utilize differential amplifiers to perform a differential amplifying mechanism to detect the voltage across the flying capacitor C_{fly1} and the voltage across the flying capacitor C_{fly2}.

FIG. 5B is a circuit diagram of a multi-level converter 1010 and voltage detection circuits 100b-1 and 100b-2 according to another embodiment of the present disclosure. The multi-level converter 1010 of FIG. 5B is similar to the multi-level converter 1010 of FIG. 5A, which also employs the configuration of a symmetrical series capacitor buck converter. Furthermore, the voltage detection circuits 100b-1 and 100b-2 of FIG. 5B are similar to the voltage detection circuit 100b of FIG. 3B, which utilize a resistor voltage dividing mechanism to detect the voltage across the flying capacitor Cfly1 and the voltage across the flying capacitor Cfly2.

In summary, the present disclosure discloses technical solutions of combining a voltage dividing resistor with a differential amplifier, or combining two sets of voltage dividing resistors with a control circuit. Compared with the isolated voltage detection circuit chips or optical couplers utilized in prior arts, the technical solutions utilized by the present disclosure can greatly reduce the area and element cost of the circuit used to detect the voltage of the flying capacitor.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A multi-level processing system, comprising:
a multi-level converter, comprises a key element, a plurality of control switch elements and a plurality of target switch elements, wherein the key element is electrically coupled to at least one of the control switch elements, and the key element has a voltage parameter set;
a voltage detection circuit, electrically coupled to the key element of the multi-level converter to detect the voltage parameter set, and generate a detection voltage set based on the voltage parameter set; and
a control circuit, electrically coupled to the voltage detection circuit to receive the detection voltage set, and utilizes the detection voltage set as a control voltage set of the control circuit.

2. The multi-level processing system of claim 1, wherein at least one of the control switch elements and the key element are electrically coupled to a first ground end, and at least one of the target switch elements is electrically coupled to a second ground end, the first ground end has a potential which is different from a potential of the second ground end.

3. The multi-level processing system of claim 1, wherein the key element is a flying capacitor, and the flying capacitor is connected across at least two of the control switch elements, and the voltage parameter set comprises a first end voltage of a first end of the flying capacitor and a second end voltage of a second end of the flying capacitor.

4. The multi-level processing system of claim 3, wherein the voltage detection circuit comprising:
a differential amplifier, having a first input end for receiving a first input voltage, a second input end for receiving a second input voltage, and an output end for outputting a differential detection voltage,
wherein, the first input voltage is associated with the first end voltage of the flying capacitor, the second input voltage is associated with the second end voltage of the flying capacitor, and the detection voltage set generated by the voltage detection circuit comprises the differential detection voltage.

5. The multi-level processing system of claim 4, wherein the control circuit utilizes a first voltage source as a reference voltage, and the differential amplifier utilizes the first voltage source as a reference voltage, and the first input voltage and the second input voltage of the differential amplifier are both less than or equal to a voltage value of the first voltage source.

6. The multi-level processing system of claim 5, wherein the second end voltage of the flying capacitor has a scaling factor relative to the first end voltage, and an upper limit voltage value of the differential detection voltage generated by the differential amplifier is associated with the voltage value of the first voltage source and the scaling factor.

7. The multi-level processing system of claim 4, wherein the voltage detection circuit further comprising:
a first peripheral resistor, electrically coupled between the first input end of the differential amplifier and the first end of the flying capacitor; and
a second peripheral resistor, electrically coupled between the second input end of the differential amplifier and the second end of the flying capacitor, wherein the first peripheral resistor and the second peripheral resistor have a same first resistance value.

8. The multi-level processing system of claim 7, wherein the voltage detection circuit further comprising:
a third peripheral resistor, electrically coupled between the first input end and the output end of the differential amplifier; and
a fourth peripheral resistor, electrically coupled between the second input end of the differential amplifier and the second ground end,
wherein the third peripheral resistor and the fourth peripheral resistor have a same second resistance value.

9. The multi-level processing system of claim 8, wherein the differential detection voltage is equal to the product of a difference between the second end voltage and the first end voltage of the flying capacitor and the ratio of the second resistance value relative to the first resistance value.

10. The multi-level processing system of claim 4, wherein the control circuit utilizes a first voltage source as a reference voltage, and the differential amplifier utilizes a second voltage source as a reference voltage, the voltage value of the second voltage source is different from the voltage value of the first voltage source.

11. The multi-level processing system of claim 10, wherein an upper limit voltage value of the differential detection voltage generated by the differential amplifier is equal to the voltage value of the first voltage source.

12. The multi-level processing system of claim 3, wherein the voltage detection circuit comprising:
a first voltage dividing resistor, electrically coupled to the first end of the flying capacitor; and
a second voltage dividing resistor, electrically coupled between the first voltage dividing resistor and the second ground end,
wherein, a coupling point between the first voltage dividing resistor and the second voltage dividing resistor provides a first detection voltage, and the detection voltage set generated by the voltage detection circuit includes the first detection voltage.

13. The multi-level processing system of claim 12, wherein the first detection voltage is equal to a product of a series voltage dividing ratio of the first voltage dividing resistor and the second voltage dividing resistor and the first end voltage of the flying capacitor, and an upper limit voltage value of the first detection voltage is equal to the voltage value of the first voltage source.

14. The multi-level processing system of claim 3, wherein the voltage detection circuit comprising:
a third voltage dividing resistor, electrically coupled to the second end of the flying capacitor; and
a fourth voltage dividing resistor, electrically coupled between the third voltage dividing resistor and the second ground end,
wherein, the coupling point between the third voltage dividing resistor and the fourth voltage dividing resistor provides a second detection voltage, and the detection voltage set generated by the voltage detection circuit comprises the second detection voltage.

15. The multi-level processing system of claim 14, wherein the second detection voltage is equal to a product of a series voltage dividing ratio of the third voltage dividing resistor and the fourth voltage dividing resistor and the second end voltage of the flying capacitor, and an upper limit voltage value of the second detection voltage is equal to the voltage value of the first voltage source.

16. The multi-level processing system of claim 12, wherein the control circuit performs a control operation based on the control voltage set, and the control operation comprises a subtraction operation of the first detection voltage and the second detection voltage.

17. The multi-level processing system of claim 14, wherein the control circuit performs a control operation based on the control voltage set, and the control operation comprises a subtraction operation of the first detection voltage and the second detection voltage.
